(19) United States
(12) Patent Application Publication
(10) Pub. No.: US 2007/0160314 A1
(43) Pub. Date: Jul. 12, 2007

(54) Bidirectional hydrodynamic thrust bearing

(76) Inventors: Aaron Richie, Houston, TX (US); Lannie L. Dietle, Houston, TX (US)

Correspondence Address: ANDREWS & KURTH, L.L.P., 600 TRAVIS, SUITE 4200, HOUSTON, TX, 77002, US

(21) Appl. No.: 11/638,889

(22) Filed: Dec. 14, 2006

Related U.S. Application Data
(60) Provisional application No. 60/758,039, filed on Jan. 11, 2006.

(51) Int. Cl. F16C 32/06

(52) U.S. Cl. 384/121

(57) ABSTRACT

A thrust bearing assembly including a flexible thrust washer sandwiched between first and second races. The thrust washer includes notches between adjacent support regions. When a thrust load is applied to the bearing assembly, the thrust washer elastically flexes at the notched or unsupported regions and creates undulations in the washer's dynamic surface to create an initial hydrodynamic fluid wedge with respect to the corresponding dynamic surface of the second race. The gradually converging geometry created by these undulations promotes a strong hydrodynamic action that wedges a lubricant film of a predictable magnitude into the dynamic interface between the thrust washer and the second race in response to relative rotation. This lubricant film physically separates the dynamic surfaces of the thrust washer and second race from each other, thus minimizing asperity contact, and reducing friction, wear and bearing-generated heat, while permitting operation at higher load and speed combinations.

### CROSS-REFERENCE TO RELATED APPLICATIONS

This application claims the benefit of U.S. Provisional Application Ser. No. 60/758,039, filed Jan. 11, 2006, and entitled “Bidirectional Hydrodynamic Thrust Bearing.”

### BACKGROUND OF THE INVENTION

1. Field of the Invention

The present invention relates generally to thrust bearing assemblies, and more particularly to thrust bearing assemblies providing hydrodynamic lubrication of the loaded bearing surfaces in response to relative rotation.

2. Description of the Related Art

Rotary drilling techniques are used to penetrate into the earth to create wells for obtaining oil and gas. In order to drill through the rock that is encountered in such endeavors, a drill bit is employed at the bottom of a hollow drill string.

In many cases, rotary motion is imparted to the drill bit by a downhole mud motor that employs a sealed bearing assembly containing thrust and radial bearings that guide the rotation of the drill bit, and transfer the weight of the drill string to the drill bit. Mud motor sealed bearing assemblies are well known in the prior art; for example see U.S. Pat. Nos. 3,730,284; 5,195,754; 5,248,204; 5,664,891; and 6,416,225.

The thrust bearings that are employed in mud motor sealed bearing assemblies are typically conventional roller thrust bearings. Relative to their small size, these bearings are severely loaded, and the bearing contact stresses reach extremely high levels, especially during severe impact loading. The races of roller thrust bearings are subject to Brinnelling-type damage from the high impact forces that are encountered in drilling operations, which can lead to premature bearing failure.

In order to replace the mud motor at the end of its useful life, it is necessary to first pull the entire drill string from the well. The downtime associated with the lengthy round trips required for such replacement can be a significant component of the cost of drilling a well, particularly in wells of great depth. A significant reduction in the cost of oil and gas well drilling can therefore be obtained by improving the reliability and life of the thrust bearing used in oilfield mud motor sealed bearing assemblies.

It is desirable to have a reliable, compact, impact-resistant thrust bearing assembly for use in mechanical equipment subject to high bearing loads, including oilfield mud motor sealed bearing assemblies and other rotary equipment. It is further desirable to have a thrust bearing assembly that is load responsive and provides hydrodynamic lubrication of the bearing dynamic surfaces in response to relative rotation. It is further desirable to have a thrust bearing assembly that carries heavy loads at high speeds while generating less heat than prior art non-hydrodynamic thrust bearings. It is further desirable that the thrust bearing be economical.

### SUMMARY OF THE INVENTION

It is an objective of the present invention to provide a reliable, economical, impact resistant thrust bearing for use in mechanical equipment subject to high bearing loads, such as oilfield downhole mud motor sealed bearing assemblies used in hard rock drilling and other rotary equipment.

It is another objective of this invention to provide a compact hydrodynamically lubricated bearing that lowers bearing friction to permit operation under higher loads and higher speeds while minimizing bearing wear, preventing seizure, and remaining effective even as wear occurs at the bearing interface.

It is another objective of this invention to reduce bearing generated heat to prevent heat-related degradation of lubricant, bearings, elastomer seals, and associated components.

It is another objective of this invention to provide a compact bearing that can withstand high shock loads without damage, while maintaining low friction operation.

It is another objective of this invention to provide a compact bearing that permits low friction operation over a wide range of loads, and while rotating in either clockwise or counter-clockwise direction.

It is another objective of this invention to provide a reliable thrust bearing assembly for rotary equipment by providing a load responsive, elastically flexing bearing design that provides hydrodynamic lubrication of the loaded dynamic surfaces.

The thrust bearing assembly according to a preferred embodiment of the present invention provides an improved thrust bearing arrangement for supporting and guiding a relatively rotatable member. The arrangement preferably comprises a generally circular, ring-like first race, a thrust washer of generally ring-like design, and a generally circular, ring-like second race having a dynamic surface. The thrust washer is sandwiched between the first and second races.

In a preferred embodiment the thrust washer has a dynamic surface and a castellated end configuration defining a plurality of support regions and a plurality of undercut (i.e., notched) regions between adjacent support regions. Preferably, the undercut regions are open-ended, i.e., passing completely through the thrust washer from side to side.

The castellated end configuration of the thrust washer provides intermittent support to the thrust washer, and also provides intermittent unsupported regions. When a thrust load is applied to the bearing assembly, the thrust washer elastically flexes at the unsupported regions. This flexure creates undulations in the thrust washer's dynamic surface in response to the applied load, to create an initial hydrodynamic fluid wedge with respect to the dynamic surface of the second race. The gradually converging geometry created by these undulations promotes a strong hydrodynamic action that wedges a lubricant film of a predictable magnitude into the dynamic interface between the dynamic surfaces of the thrust washer and the second race in response to relative rotation. This lubricant film physically separates the dynamic surfaces of the thrust washer and second race from each other, thus minimizing asperity contact, and reducing friction, wear and bearing-generated heat, while permitting operation at higher load and speed combinations.

In an alternate embodiment, the thrust washer has a first dynamic washer surface facing a first race dynamic surface, and a second dynamic washer surface facing a second race dynamic surface. The thrust washer preferably includes a plurality of notches extending radially through the thrust washer with the notches separated by pedestals. Each of the notches defines first and second washer flexing regions.

### BRIEF DESCRIPTION OF THE SEVERAL VIEWS OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a plan view of a hydrodynamic thrust bearing assembly according to a preferred embodiment of the present invention;

FIG. 1A is a section view taken along lines 1A-1A of FIG. 1;

FIG. 1B is a fragmentary section view taken along lines 1B-1B of FIG. 1;

FIG. 1C is an enlarged fragmentary section view similar to FIG. 1B, and showing elastic deflection under thrust loading with the deflection exaggerated for purpose of illustration;

FIG. 2 is a cross-sectional elevation view of an alternate embodiment of the hydrodynamic thrust bearing assembly of the present invention;

FIG. 2A is a cross-sectional elevation view of the hydrodynamic thrust bearing assembly of FIG. 2 shown in conjunction with a shaft and housing;

FIGS. 3 and 4 are plan views of alternate embodiments of the hydrodynamic thrust bearing assembly of the present invention;

FIG. 5 is a perspective view of an alternate embodiment of the thrust washer according to the present invention;

FIG. 5A is an enlarged fragmentary cross-sectional view of the thrust washer of FIG. 5;

FIG. 6 is a cross-sectional elevation view of an alternate embodiment of the thrust washer according to the present invention;

FIG. 7 is a view similar to FIG. 1B of another embodiment of the thrust washer according to the present invention, the thrust washer having a weakening slot in the notch;

FIG. 8 is a view similar to FIG. 1B of another embodiment of the thrust washer according to the present invention;

FIG. 8A is an enlarged fragmentary section view similar to FIG. 8, and showing elastic deflection under thrust loading with the deflection exaggerated for purpose of illustration; and

FIGS. 9 and 10 are perspective views of alternate embodiments of the thrust washer according to the present invention.

### DESCRIPTION OF THE PREFERRED EMBODIMENTS

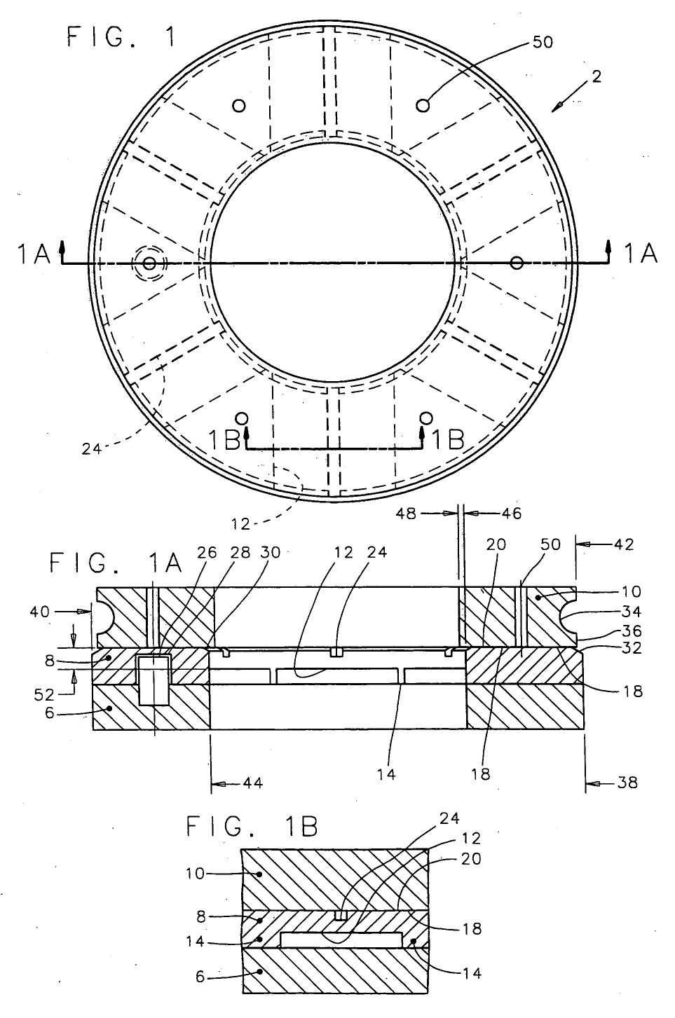

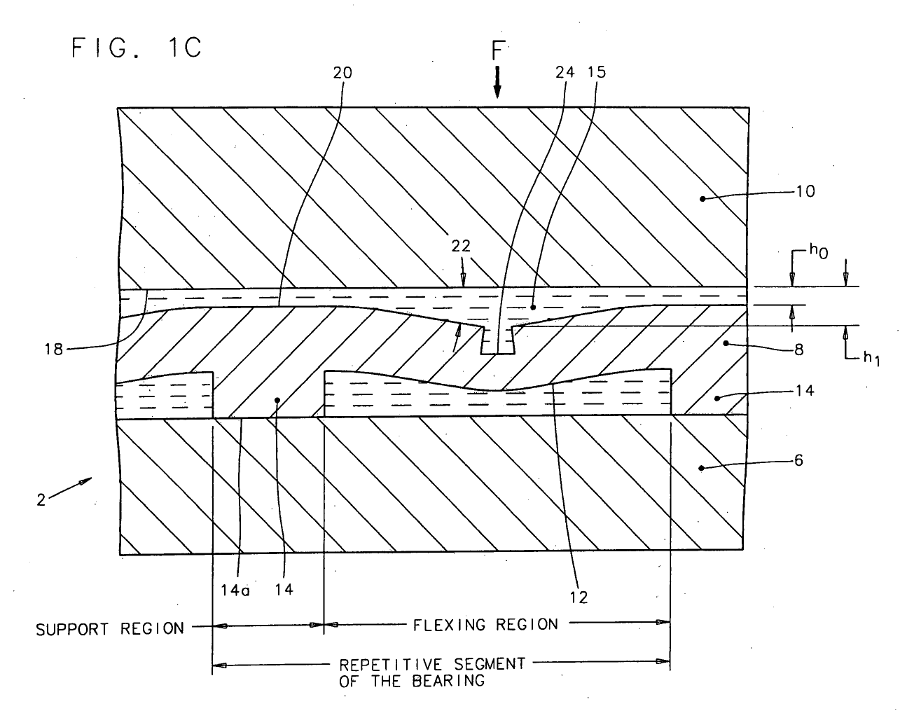

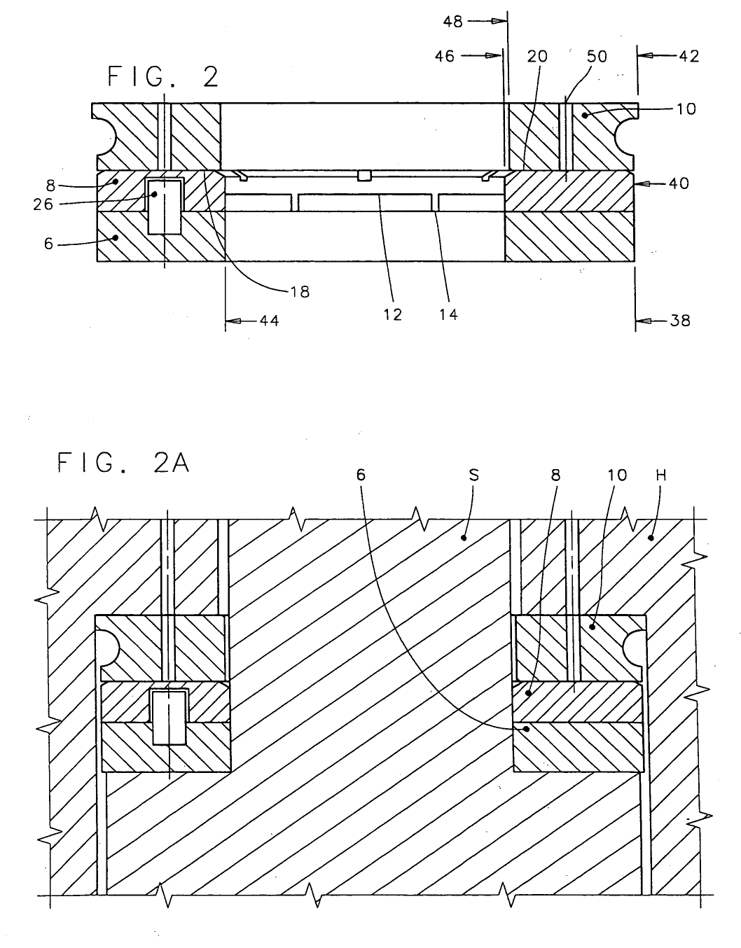

The preferred embodiment of the thrust bearing assembly according to the present invention is generally referenced in FIG. 1 as reference numeral 2. FIGS. 1 and 1A-1C illustrate a preferred embodiment of the hydrodynamic thrust bearing assembly 2 of the present invention. With reference to FIG. 2A, one of the primary purposes of the thrust bearing assembly 2 of the present invention is to transfer a thrust load between one member, such as a housing H, and another member, such as a shaft S, of a machine where the housing H and the shaft S are relatively rotatable with respect to one another.

The preferred embodiment of the thrust bearing assembly 2 includes three principal components: a first race 6, a thrust washer 8, and a second race 10. The thrust washer 8 is sandwiched between the first race 6 and the second race 10. Preferably, the thrust washer 8 has a dynamic washer surface 20 of substantially planar configuration. The second race 10 incorporates a dynamic race surface 18 of substantially planar configuration that faces the dynamic washer surface 20 of the thrust washer 8. The first race 6 and the second race 10 are relatively rotatable with respect to one another. In one preferred embodiment, the thrust washer 8 is stationary with respect to the first race 6 and is therefore relatively rotatable with respect to the second race 10.

In one preferred embodiment, the thrust washer 8 is a generally ring-like component that incorporates a plurality of generally radially-oriented notches 12 that define a plurality of pedestals 14 that contact the first race 6. As a result, this embodiment of the thrust washer 8 has a castellated appearance, with the notches 12 forming the crenellations. The notches 12 are preferably open-ended, passing completely through the local radial width of the thrust washer 8. Referring to FIG. 1C, the area of the pedestal end surface 14a defines a washer support region and the area of each notch 12 between adjacent pedestals 14 defines a washer flexing region. Preferably, in this embodiment the washer support and flexing regions define a repetitive segment of the thrust washer 8.

In the preferred embodiment, the notches 12 have substantial bilateral symmetry, unlike the bearings in commonly assigned U.S. Pat. No. 6,460,635 titled “Load Responsive Hydrodynamic Bearing, and contrary to conventional wisdom, the bidirectional bearings of the present invention perform approximately as well in either direction of rotation as the optimized unidirectional bearings of commonly assigned U.S. Pat. No. 6,460,635 do in their preferred direction of rotation.

In the embodiment shown in FIGS. 1 and 1A-1C, the number of notches 12 in the thrust washer 8 will typically vary from a minimum of 2 to 10 for bearing assemblies that are employed in oilfield mud motor sealed bearing assemblies, depending upon the thrust washer size, thickness, thrust washer material, and required load capacity. However, there is no upper limit to the number of notches 12 that may be employed in larger size thrust washers 8 used in equipment other than mud motor sealed bearing assemblies.

As shown in FIG. 1C, a lubricant 15 is provided to lubricate the bearing assembly 2. This lubricant may be a grease that is heavily loaded with solid lubricants as, for example, graphite, molybdenum disulphide, polytetrafluoroethylene (“PTFE”), powdered calcium fluoride, or copper particles combined with one or more types of soap base. However, in order to minimize rotary seal damage and thereby prolong the effective life of the thrust bearing assembly 2 as well, it is preferred that the lubricant 15 be a liquid oil-type lubricant, especially a high viscosity, synthetic lubricant having a viscosity of 900 centistokes or more at 40° C.

As also shown in FIG. 1C, when a thrust load F is transferred through the thrust bearing assembly 2 of this embodiment of the present invention, the intermittent support provided by the pedestals 14 of the thrust washer 8 results in bowing and elastic deflection in the notched flexing region of the thrust washer 8. This elastic deflection is shown in exaggerated scale in FIG. 1C for purpose of illustration. The load distribution causes the originally flat dynamic washer surface 20 to deflect, and establishes an initial convergent gap between dynamic race surface 18 and dynamic washer surface 20, known as a hydrodynamic fluid wedge 22. The presence of this initial gap ensures development of hydrodynamic lubrication action whenever relative rotation between thrust washer 8 and second race 10 occurs.

In this embodiment, during relative rotation between the first race 6 and the second race 10, the thrust washer 8 remains stationary relative to the first race 6, and relative rotation occurs between the dynamic race surface 18 and the dynamic washer surface 20, causing the hydrodynamic fluid wedge 22 to sweep a film of the lubricant 15 into the dynamic interface between dynamic race surface 18 and dynamic washer surface 20.

The relative velocity and the convergent gap of the hydrodynamic fluid wedge 22 cause a hydrodynamic wedging action that creates a lubricant film thickness and pressure creating a lifting action that separates the dynamic race surface 18 from the dynamic washer surface 20. The film thickness varies from a minimum value of h₀ to a maximum value of h₁ as shown in FIG. 1C. The film pressures thus generated are high enough to eliminate the direct rubbing contact between the majority of the asperities of dynamic race surface 18 and dynamic washer surface 20. The lubricant film reduces friction and enhances bearing performance, allowing the bearing assembly 2 to operate cooler and withstand higher load and speed combinations than are possible with conventional non-hydrodynamic thrust washers.

The bearing arrangement of the preferred embodiment produces the same level of hydrodynamic lubrication effect in either direction of rotation because of the symmetry of the design. Contrary to conventional wisdom, the bidirectional bearings of the present invention perform approximately as well in either direction of rotation as the optimized unidirectional bearings of commonly assigned U.S. Pat. No. 6,460,635 titled “Load Responsive Hydrodynamic Bearing,” do in their one preferred direction of rotation. Such optimized unidirectional commercial bearings are illustrated in Kalsi Engineering, Inc. Brochure PN 534-1, Rev. 1. Applicants have found that the bidirectional thrust bearings of the present invention are capable of handling approximately 90% of the load capacity of Kalsi Engineering's unidirectional thrust bearings. Due to the hydrodynamic pressure generation, the deflection of thrust washer 8 increases under relative rotation, as compared to the deflection under static load conditions.

The temperature reduction provided by the preferred embodiments of the present invention is of particular significance to applications where an elastomeric rotary shaft seal is positioned near the bearings to retain the bearing lubricant and to exclude abrasives. By reducing the bearing-generated heat, the rotary shaft seals are permitted to run cooler, which extends the service life of the rotary shaft seals, and therefore extends the equipment service life by preventing loss of lubricant 15 and preventing abrasive invasion of the bearings.

Preferably, the pedestals 14 of the thrust washer 8 remain stationary with respect to the first race 6 during rotary operation due to the fact that the friction at this interface is significantly higher than at the hydrodynamically lubricated dynamic interface between dynamic race surface 18 and dynamic washer surface 20. In order to prevent potential slippage during operation, as well as during start-up, the first race 6 and/or the end surface 14a of the pedestals 14 should be provided with a roughened surface finish to assure high friction. The roughened finish can be obtained by grit blasting or etching, or other equally suitable methods. If desired, the bearing assembly 2 can incorporate one or more anti-rotation features to provide engagement and prevent rotational slippage between the thrust washer 8 and the first race 6. For example, as shown in FIG. 1A, an anti-rotation projection 26 can engage an anti-rotation recess 28 to positively prevent relative rotation between the first race 6 and the thrust washer 8. The anti-rotation projection 26 can be formed in either the first race 6 (as shown in FIG. 1A) or the thrust washer 8, with the anti-rotation recess 28 being formed in the other part.

If desired, the thrust washer 8 may incorporate one or more lubricant passages 24 to facilitate the feeding of the lubricant 15 more efficiently and directly into the hydrodynamic fluid wedge 22 without relying on hydrostatic pressure of the lubricant 15 to force the lubricant feed. The lubricant passages 24 make the bearing assembly more suitable for applications having low ambient pressure (such as in applications where the lubricant 15 is substantially at atmospheric pressure) by helping to prevent lubricant starvation. The lubricant passages 24 may also be positioned intermediate the locations of the pedestals 14 to provide the thrust washer 8 with additional flexibility in the flexing region as shown in FIG. 1C.

In downhole applications, such as the oilfield mud motor sealed bearing assembly, the lubricant pressure is typically balanced to the high ambient hydrostatic wellbore pressure. In such applications, the lubricant passages 24 are not necessary because the high hydrostatic pressure present downhole prevents the formation of any unpressurized regions or voids and automatically forces the lubricant 15 into the hydrodynamic fluid wedge 22 to maintain a continuous film at the dynamic bearing interface. In surface equipment, where such hydrostatic pressure is not present, the lubricant 15 can be supplied to achieve the lubricant feed to the bearing dynamic surface by incorporating lubricant passages 24.

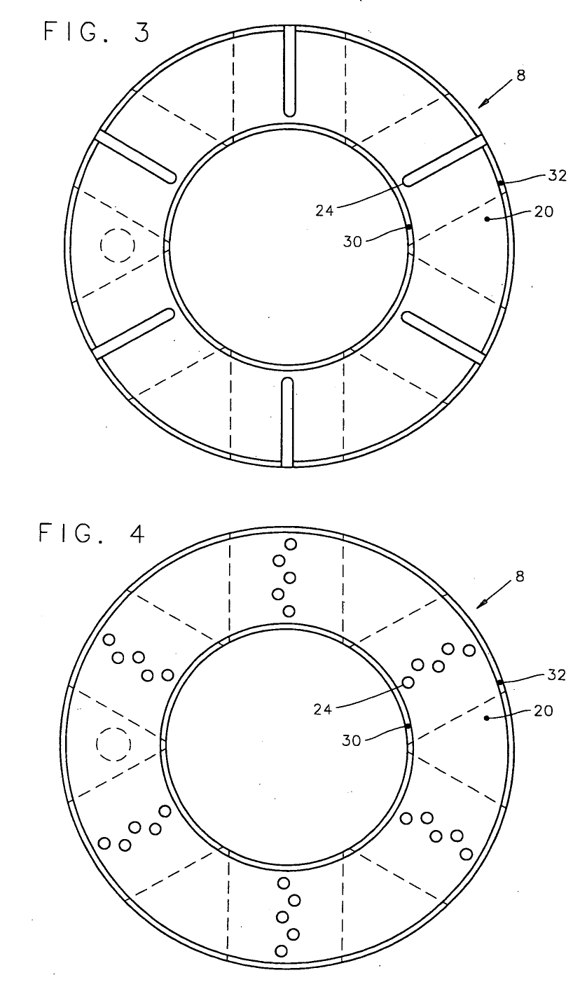

In FIGS. 1 and 1A-1C, the lubricant passages 24 take the form of substantially radially oriented slots or grooves that span the entire radial width of the thrust washer 8, however the lubricant passages 24 can take other suitable forms without departing from the spirit or scope of the invention. For example, the lubricant passages 24 may be substantially axially oriented holes as described later in conjunction with FIG. 4, or the slots of FIG. 3.

The presence of the lubricant passages 24 necessarily reduces the contact area of dynamic washer surface 20, and increases the average contact pressure at the dynamic washer surface 20 for a given thrust load. However, the increase in contact pressure is relatively small if the geometry of the lubricant passages 24 is kept small. Whenever lubricant passages 24 are incorporated in the dynamic washer surface 20, the intersections between the lubricant passages 24 and the dynamic washer surface 20 should be provided with edge-breaks such as radii or chamfers to minimize disruption of the lubricant film.

It is desirable to treat the dynamic washer surface 20 of the thrust washer 8 with a hard wear-resistant coating or other suitable wear-resistant surface treatment, and/or to make the thrust washer 8 from a wear-resistant material having good resistance to galling, such as hardened beryllium copper. The dynamic race surface 18 and/or dynamic washer surface 20 can, if desired, be treated with any suitable coating or overlay or surface treatment to provide good tribological properties, such as silver plating, carburizing, nitriding, STELLITE overlay (STELLITE is the registered trademark of Deloro Stellite Holdings Corporation for a cobalt-based hard facing alloy), COLMONOY overlay (COLMONOY is the registered trademark of Wall Colmonoy Corporation for a hard facing material), boronizing, etc., as appropriate to the base material and mating material that are employed.

Dynamic race surface 18 of the second race 10 should be softer and less wear resistant than dynamic washer surface 20 for best bearing life, to achieve the highest tolerance to overload conditions, and to better tolerate starting up under load. This can be achieved by coating the dynamic race surface 18 with silver, or with another relatively soft sacrificial coating. This can also be achieved by manufacturing the second race 10 from a conventional composite bearing material such as a porous sintered bronze impregnated with PTFE; for example, the DPF bearing material sold by Glacier Garlock Bearings (GGB).

It is preferred that no silver plating be applied to dynamic washer surface 20 so that dynamic washer surface 20 is more tolerant of overload conditions. Since silver coating does provide a measure of boundary lubrication under overload conditions, it is instead preferred that the silver coating or other suitable sacrificial coating be applied to the mating dynamic race surface 18 rather than to dynamic washer surface 20. With such a preferred coating arrangement, during overload conditions and/or when starting up under load, the silver plating wears off uniformly from dynamic race surface 18 and does not affect the hydrodynamic wedging angle of the unplated dynamic washer surface 20.

Even though beryllium copper is mentioned as a suitable material choice for the thrust washer 8, any number of alternative suitable materials with appropriate elastic modulus, strength, temperature capability, and boundary lubrication characteristics can be employed without departing from the spirit or scope of the invention, such as (but not limited to) steel, STELLITE, ductile iron, white iron, etc. A thrust washer 8 constructed with a material having a higher elastic modulus will, however, require the notches 12 and pedestals 14 to have different proportions than would be appropriate for a thrust washer 8 constructed with a material having a lower elastic modulus.

By proper design of the flexibility of the thrust washer 8, the hydrodynamic performance can be adjusted to cover anticipated service conditions and cover a wide range of thrust loading. Flexibility is a function of washer thickness 52, the size and location of the lubricant passages 24 (if any), the elastic modulus of the thrust washer 8, and the number, shape and size of the notches 12 and pedestals 14. It can also be appreciated that it is possible to vary the hydrodynamic performance of individual repetitive segments within a given bearing assembly for all the various embodiments of load responsive, elastically flexing bearings shown and described herein.

As shown in FIG. 1A, the dynamic washer surface 20 is preferably provided with an inner edge-relief corner break 30 and an outer edge-relief corner break 32 to reduce edge loading and high edge stresses. For example, when the present invention is employed in oilfield mud motor sealed bearing assemblies, edge loading can be caused by unavoidable bending moments imposed on the rotating shaft of the mud motor by drilling forces.

Still referring to FIG. 1A, the second race 10 is preferably equipped with an undercut 34, preferably a peripheral undercut, that establishes a flexible ledge 36. When bearing edge loading occurs, flexure of the flexible ledge 36 significantly reduces edge stresses on the thrust washer 8. The flexible ledge 36 is designed to have sufficient stiffness to provide load support to the thrust washer 8, yet be flexible enough to significantly reduce edge loading contact stress to reduce wear of the dynamic washer surface 20 and the dynamic race surface 18.

In the embodiment of FIGS. 1 and 1A-1C, the first race outside diameter (“OD”) 38 and the washer OD 40 are larger than the second race OD 42. This configuration, which is common in prior art rolling element thrust bearings, allows the first race 6 and the thrust washer 8 to be guided (i.e., laterally located) by a close fit with a housing bore (not shown), and allows the second race 10 to have clearance with the housing bore. The first race inside diameter (“ID”) 44 and the washer ID 46 are larger than the second race ID 48. This configuration, which is common to the prior art, allows the second race 10 to be guided (i.e., laterally located) by a close fit with a shaft (not shown), and allows the first race 6 and the thrust washer 8 to have clearance with the shaft. If desired, the first race 6 can be an integral part of the housing, and/or the second race 10 can be an integral part of the shaft.

When subjected to heavy downhole impact loads, the conventional rolling element bearings used in mud motor sealed bearing assemblies are prone to fatigue damage and brinelling (e.g., denting) of the race surfaces. The preferred embodiment of the present invention is able to withstand much higher momentary impact loads by virtue of the hydrodynamic lubricating film in the dynamic interface between dynamic race surface 18 and dynamic washer surface 20, and the large dynamic support area, which film and area together provide a classical squeeze-film cushioning effect. When a momentary impact causes the lubricant film to be rapidly squeezed, it cannot escape instantaneously. The magnitude and duration of the load determines the reduction in film thickness and the load that can be supported. In general, the preferred embodiment of the present invention is able to handle impact loads more than three times the dynamic design load limit.

In some applications, such as oilfield rotating diverters, thrust bearings must start rotation under heavily loaded conditions, which can result in high startup torque and premature wear to the thrust washer 8 and/or second race 10. As shown in FIGS. 1, 1A and 2, this can be addressed, if desired, by routing pressurized lubricant through a pattern of pressure communication holes 50 in the second race 10 that communicate with the interface between dynamic race surface 18 and dynamic washer surface 20. This creates an initial hydrostatic film that lubricates the dynamic race surface 18 and the dynamic washer surface 20 during startup, and improves film thickness during rotary operation.

The present invention was initially conceived to enhance the wear capabilities of thrust bearings used in equipment such as oilfield downhole mud motor sealed bearing assemblies and to permit operation under high load and high speed combinations not possible with current state of the art rolling element bearing designs. The general operating principle of the present invention is also applicable to many other types of rotary equipment, with either the bearing housing or the shaft, or both, being the rotary member or members. Examples of such equipment include, but are not limited to, downhole drill bits, downhole rotary steerable equipment, rotary well control equipment, and equipment used in construction, mining, dredging, and pumps where bearings are heavily loaded, and other applications where space may be limited and operating conditions are severe.

It will be obvious to those skilled in the art that the geometry of the various embodiments of the present invention disclosed herein can be manufactured using any of a number of different processes, such as conventional machining, electric discharge machining, investment casting, die casting, die forging, etc.

Features throughout this specification that are represented by like numbers have the same function. In the alternate embodiment of FIGS. 2 and 2A, the second race 10 is designed to be guided by the housing H (FIG. 2A), while the first race 6 and thrust washer 8 are designed to be guided by the shaft S (FIG. 2A). The first race OD 38 and the washer OD 40 are smaller than the second race OD 42. This allows the second race 10 to be guided (i.e., laterally located) by a close fit with a bore of the housing H and allows the first race 6 and the thrust washer 8 to have clearance with the housing bore as shown in FIG. 2A. The first race ID 44 and the washer ID 46 are smaller than the second race ID 48. This configuration, which is common to prior art rolling element thrust bearings, allows the first race 6 and the thrust washer 8 to be guided (i.e., laterally located) by a close fit with the shaft S, and allows the second race 10 to have clearance with the shaft S as shown in FIG. 2A. If desired, the first race 6 can be an integral part of the shaft S, and/or the second race 10 can be an integral part of the housing H.

FIG. 3 is a plan view of an alternative embodiment of the thrust washer 8 having lubricant passages 24 that do not span the entire radial width of the thrust washer 8. Instead, the lubricant passages 24 span only part of the width and still accomplish the objective of feeding lubricant in applications with low lubricant pressure.

FIG. 4 is a plan view of another embodiment of the thrust washer 8 in which the lubricant passages 24 are comprised of substantially axially oriented through-holes. The use of holes minimizes the loss of load bearing area while providing communication to feed lubricant to the hydrodynamic fluid wedge, and also provide the thrust washer 8 with additional flexibility intermediate the locations of the pedestals 14 of the thrust washer 8.

The dynamic washer surface 20 is substantially flat and uninterrupted except for the small interruption caused by the holes defining the lubricant passages 24. In the exemplary geometry shown in FIG. 4, there are two holes in one row and three holes in the other row. This permits the lubricant to be readily fed in the hydrodynamic fluid wedge under load.

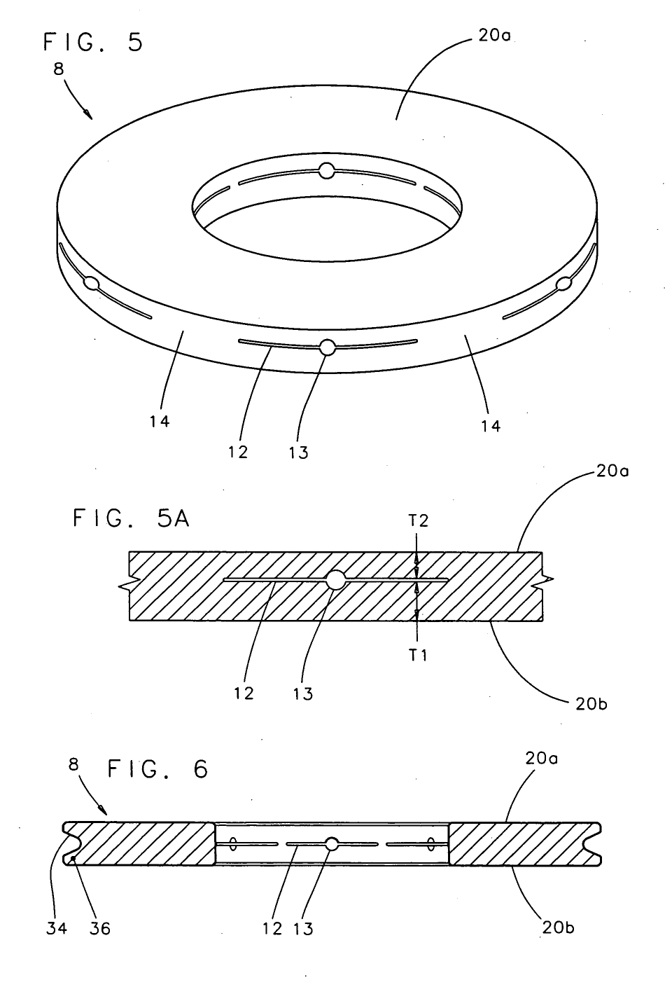

FIGS. 5 and 5A show a double-sided thrust washer 8 having two dynamic washer surfaces 20a and 20b. The notches 12 can, if desired, be produced by wire electrical discharge machining (EDM). Weakening geometry 13, which can conveniently take the form of radially drilled holes, fulfill the dual purpose of providing a starting point for the wire EDM while also providing the bearing with additional flexibility intermediate the pedestals 14. Although the drawings show the weakening geometry 13 positioned substantially equidistantly between the pedestals 14 (i.e., substantially midway between an adjacent pair of pedestals), such positioning is not required by the present invention. The double-sided thrust washer 8 of FIGS. 5 and 5A is sandwiched between two dynamic races which may, if desired, take the form of the dynamic races illustrated in FIGS. 1A and 2, with one being shaft guided and the other being housing guided. The races could also, if desired, be formed directly by surfaces of the housing and shaft.

If the location of the notches 12 is midway between dynamic washer surfaces 20a and 20b as shown in FIG. 6, each end of the thrust washer 8 will have the same load capacity. Alternatively, if the location of the notches 12 is not midway between dynamic washer surfaces 20a and 20b, each end of the thrust washer 8 will have a different load capacity. This results in one end of the thrust washer 8 being adapted for providing optimum lubrication and friction coefficient at a higher optimum load compared to the other end of the thrust washer 8. Thus, under lower magnitude loads within the optimum hydrodynamic performance zone of one end of the thrust washer 8, relative rotation will occur at the interface between that end of the thrust washer 8 and the respective mating surface of the dynamic race, and at higher magnitude loads beyond the optimum performance zone of the end discussed above, but within the optimum hydrodynamic performance zone of the opposite end, relative rotation will transition to the interface between the opposite end and the respective mating surface of the other dynamic race.

In other words, dynamic washer surfaces 20a and 20b of the thrust washer 8 of FIGS. 5 and 5A have different optimum load capabilities as governed by design differences in the respective geometry, such as employing a greater thickness T1 on one end of the thrust washer 8 compared to thickness T2 at the other end of the thrust washer, which causes dynamic washer surface 20b to be adapted for providing optimum lubrication and friction coefficient at a higher optimum load compared to dynamic washer surface 20a. Thus, under lower magnitude loads within the optimum hydrodynamic performance zone of dynamic washer surface 20a, relative rotation will occur at the interface between dynamic washer surface 20a and the respective mating surface of the dynamic race that it faces. At higher magnitude loads beyond the optimum performance zone of dynamic washer surface 20a but within the optimum hydrodynamic performance zone of dynamic washer surface 20b, relative rotation will transition to the interface between dynamic washer surface 20b and the respective mating surface of the dynamic race that it faces. Such a bearing assembly is capable of providing a low friction coefficient over a much wider load range.

It can also be appreciated that it is possible to vary the hydrodynamic performance of individual repetitive segments within a given bearing for all the various embodiments of load responsive, elastically flexing bearings shown and described herein.

In FIG. 6, the thrust washer 8 is preferably equipped with an undercut 34, preferably a peripheral undercut, that establishes at least one flexible ledge 36. When bearing edge loading occurs, flexure of the flexible ledge 36 significantly reduces edge stresses on the thrust washer 8. The flexible ledge 36 is designed to have sufficient stiffness to provide load support, yet be flexible enough to significantly reduce edge loading contact stress to reduce wear.

FIG. 7 shows a thrust washer 8 having a weakening slot 13 in the notched surface to increase flexibility, without detracting from the area of dynamic washer surface 20.

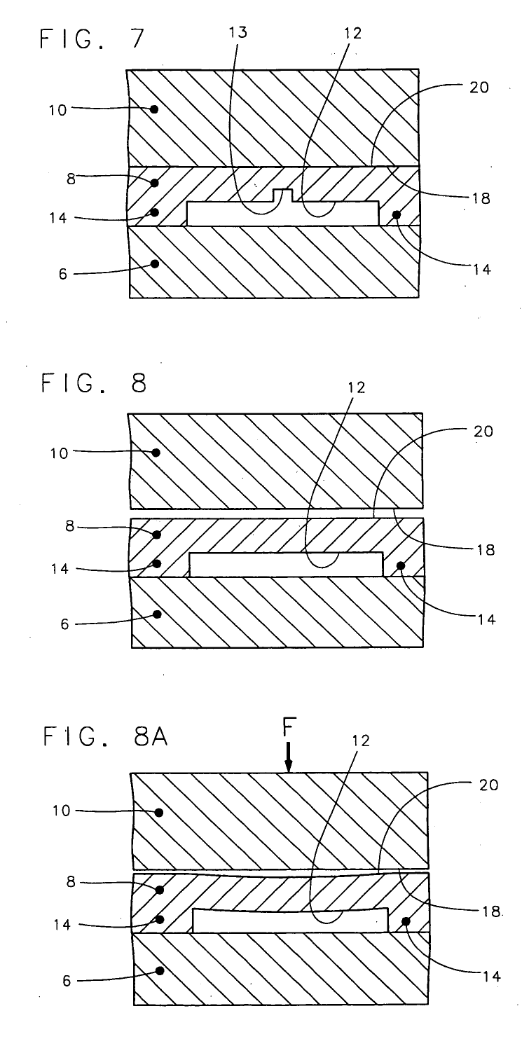

FIG. 8 shows a simplified thrust washer 8 that does not employ the lubricant passages 24 shown in FIGS. 1A-1C. The embodiment of FIG. 8 is suitable for applications that have a high lubricant pressure to assure lubricant feed. For example, in a downhole mud motor sealed bearing assembly, the lubricant is balanced to the high ambient wellbore pressure, which can be thousands of pounds per square inch of pressure.

FIG. 8A shows the simplified thrust washer 8 of FIG. 8 while loaded, with deflection exaggerated for purpose of illustration.

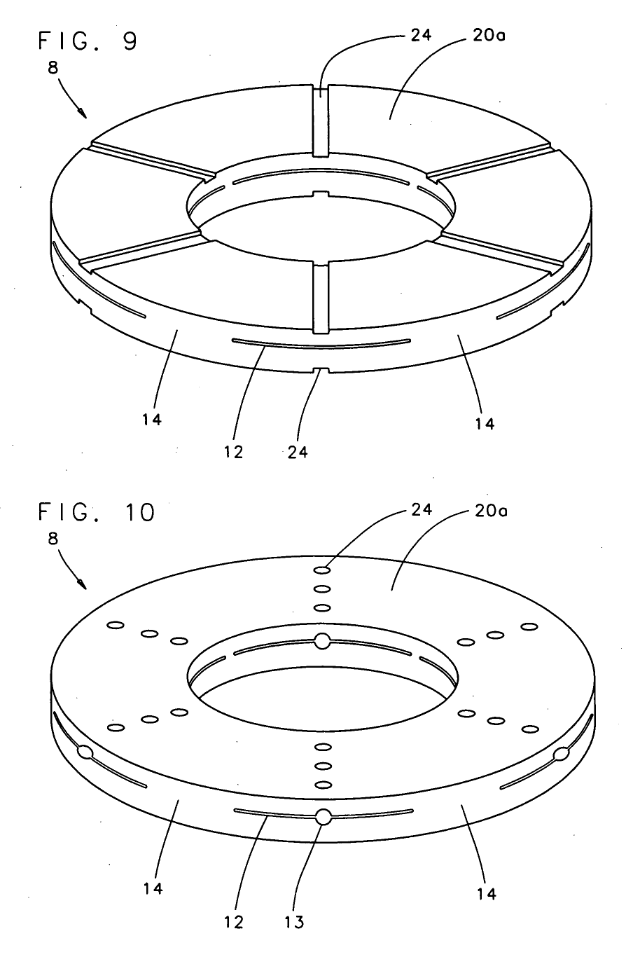

As shown in FIG. 9, a thrust washer 8 of the type shown generally in FIGS. 5, 5A and 6 may incorporate one or more lubricant passages 24 to facilitate the feeding of the lubricant more efficiently and directly into the hydrodynamic fluid wedge without relying on hydrostatic pressure of the lubricant to force the lubricant feed. The lubricant passages 24 make the thrust washer 8 more suitable for applications having low ambient pressure (such as in applications where the lubricant is substantially at atmospheric pressure) by helping to prevent lubricant starvation. The lubricant passages 24 may also be positioned intermediate the locations of the pedestals 14 to provide the thrust washer 8 with additional flexibility in the flexing region.

As shown in FIG. 10, a thrust washer 8 of the type shown generally in FIGS. 5, 5A, 6 and 9 may incorporate lubricant passages 24 that are comprised of substantially axially oriented through-holes. The use of holes minimizes the loss of load bearing area while providing communication to feed lubricant to the hydrodynamic fluid wedge, and also provide the thrust washer 8 with additional flexibility intermediate the locations of the pedestals 14 of the thrust washer 8. The dynamic washer surfaces are substantially flat and uninterrupted except for the small interruption caused by the holes defining the lubricant passages 24.

Contrary to conventional wisdom, the preferred embodiment of the bearing arrangement of FIGS. 5, 5A, 9, 10 and all the other figures herein will produce the same level of hydrodynamic lubrication effect in either direction of rotation because of the bilateral symmetry of the notches 12.

The preferred embodiment of the bearing assembly of the present invention provides a reliable, economical, impact resistant thrust bearing for use in mechanical equipment subject to high bearing loads, such as oilfield downhole mud motor sealed bearing assemblies used in hard rock drilling and other rotary equipment.

The present invention preferably provides a compact hydrodynamically lubricated bearing that lowers bearing friction to permit operation under higher loads and higher speeds while minimizing bearing wear, preventing seizure, and remaining effective even as wear occurs at the bearing interface. Preferably, the bearing assembly of the present invention reduces bearing generated heat to prevent heat-related degradation of lubricant, bearings, elastomer seals, and associated components.

The hydrodynamic thrust bearing according to the preferred embodiment of the present invention includes a thrust washer that elastically deflects under load and hydroplanes on a lubricant film during rotation. The deflection creates regions of gradual convergence between the thrust washer and the mating surface of the dynamic race that act as efficient hydrodynamic inlets. During rotation, these inlets force lubricant into the dynamic interface, creating a load-supporting interfacial lubricant film that significantly reduces bearing friction, wear and heat.

The preferred embodiment of the present invention can withstand high shock loads without damage, while maintaining low friction operation and while rotating in either clockwise or counter-clockwise direction.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

We claim:

1. A hydrodynamic bearing assembly for supporting and guiding a relatively rotatable member, the hydrodynamic bearing assembly comprising:
a first race having a static race surface;
a second race having a dynamic race surface; and
a thrust washer positioned between said first race and said second race, said thrust washer having a dynamic washer surface facing said dynamic race surface and a plurality of notches defined by a plurality of pedestals, said plurality of pedestals facing said static race surface,
wherein each of said plurality of notches defines a washer flexing region.

2. The hydrodynamic bearing assembly of claim 1, further comprising an anti-rotation projection preventing rotational slippage between said first race and said thrust washer.

3. The hydrodynamic bearing assembly of claim 2, wherein said anti-rotation projection projects from said first race and engages an anti-rotation recess in said thrust washer.

4. The hydrodynamic bearing assembly of claim 2, wherein said anti-rotation projection projects from said thrust washer and engages said first race.

5. The hydrodynamic bearing assembly of claim 1, wherein said thrust washer includes a lubricant passage.

6. The hydrodynamic bearing assembly of claim 5, wherein said lubricant passage is a recessed slot in said dynamic washer surface.

7. The hydrodynamic bearing assembly of claim 5, wherein said lubricant passage is a hole that passes through said thrust washer from said dynamic washer surface to one of said plurality of notches.

8. The hydrodynamic bearing assembly of claim 7, further comprising a weakening geometry located substantially midway between an adjacent pair of said plurality of pedestals.

9. The hydrodynamic bearing assembly of claim 1, further comprising a weakening geometry located substantially midway between an adjacent pair of said plurality of pedestals.

10. The hydrodynamic bearing assembly of claim 1, further comprising a lubricant lubricating a dynamic interface between said dynamic race surface and said dynamic washer surface during relative rotation therebetween.

11. The hydrodynamic bearing assembly of claim 10, wherein during relative rotation between said dynamic race surface and said dynamic washer surface, said dynamic interface is lubricated substantially the same during either clockwise or counter-clockwise relative rotation.

12. The hydrodynamic bearing assembly of claim 1, wherein each said notch of said plurality of notches is substantially bilaterally symmetrical.

13. The hydrodynamic bearing assembly of claim 1, wherein said second race includes a plurality of pressure communication holes.

14. The hydrodynamic bearing assembly of claim 13, wherein each of said plurality of pressure communication holes passes substantially axially through said second race.

15. The hydrodynamic bearing assembly of claim 1, wherein said second race includes a peripheral undercut defining a flexible ledge.

16. The hydrodynamic bearing assembly of claim 1, wherein:
said second race has a second race outside diameter and a second race inside diameter; and
said first race has a first race outside diameter and a first race inside diameter,
wherein said second race outside diameter is larger than said first race outside diameter, and said second race inside diameter is larger than said first race inside diameter.

17. The hydrodynamic bearing assembly of claim 1, wherein:
said second race has a second race outside diameter and a second race inside diameter; and
said first race has a first race outside diameter and a first race inside diameter,
wherein said second race outside diameter is smaller than said first race outside diameter, and said second race inside diameter is smaller than said first race inside diameter.

18. The hydrodynamic bearing assembly of claim 1, wherein said thrust washer includes at least one weakening geometry intermediate two of said plurality of pedestals.

19. The hydrodynamic bearing assembly of claim 1, wherein each of said plurality of pedestals includes an end surface and at least a portion of said end surfaces is roughened to increase friction between said plurality of pedestals and said static race surface.

20. The hydrodynamic bearing assembly of claim 1, wherein at least a portion of said static race surface is roughened to increase friction between said plurality of pedestals and said static race surface.

21. The hydrodynamic bearing assembly of claim 1, wherein said dynamic race surface of said second race is silver plated.

22. A load responsive, hydrodynamic bearing assembly for supporting and guiding a first member rotatable relative to a second member, the bearing assembly comprising:
a first race having a static race surface;
a ring shaped second race having a dynamic race surface; and
a ring shaped, flexible thrust washer positioned between said first race and said second race, said flexible thrust washer having a plurality of notches defined by a plurality of pedestals, said plurality of pedestals facing said static race surface, said flexible thrust washer having a dynamic washer surface facing said dynamic race surface,
wherein a plurality of flexing regions are defined by said plurality of notches.

23. The hydrodynamic bearing assembly of claim 22, wherein during rotation of the first member relative to the second member, said dynamic race surface rotates relative to said dynamic washer surface forming a dynamic interface therebetween.

24. The hydrodynamic bearing assembly of claim 23, wherein said flexible thrust washer is rotationally stationary relative to said first race.

25. The hydrodynamic bearing assembly of claim 23, wherein said plurality of notches are open-ended notches such that said static race surface is not in contact with said flexible thrust washer at said plurality of flexing regions.

26. The hydrodynamic bearing assembly of claim 25, further comprising a lubricant lubricating said dynamic interface between said dynamic race surface and said dynamic washer surface during relative rotation therebetween.

27. The hydrodynamic bearing assembly of claim 26, wherein said lubricant is a pressurized lubricant and a film of lubricant is swept into said dynamic interface during relative rotation between said dynamic race surface and said dynamic washer surface.

28. The hydrodynamic bearing assembly of claim 26, wherein said flexible thrust washer elastically deforms in use to provide a hydrodynamic fluid wedge at said dynamic interface between said dynamic washer surface and said dynamic race surface.

29. The hydrodynamic bearing assembly of claim 27, wherein said pressurized lubricant establishes separation between said dynamic race surface and said dynamic washer surface.

30. The hydrodynamic bearing assembly of claim 22, wherein said dynamic washer surface is substantially planar.

31. The hydrodynamic bearing assembly of claim 30, wherein said dynamic race surface is substantially planar.

32. The hydrodynamic bearing assembly of claim 30, wherein said flexible thrust washer includes a plurality of lubricant passages.

33. The hydrodynamic bearing assembly of claim 32, wherein said plurality of lubricant passages comprise a plurality of recessed slots in said dynamic washer surface.

34. The hydrodynamic bearing assembly of claim 32, wherein said plurality of lubricant passages comprise a plurality of holes that pass through said flexible thrust washer from said dynamic washer surface to one of said plurality of notches.

35. The hydrodynamic bearing assembly of claim 30, wherein said second race includes a plurality of pressure communication holes.

36. The hydrodynamic bearing assembly of claim 35, wherein each of said plurality of pressure communication holes passes substantially axially through said second race.

37. The hydrodynamic bearing assembly of claim 23, wherein said flexible thrust washer elastically deforms in use to provide a hydrodynamic fluid wedge at said dynamic interface between said dynamic washer surface and said dynamic race surface.

38. The hydrodynamic bearing assembly of claim 22, further comprising a lubricant lubricating a dynamic interface between said dynamic race surface and said dynamic washer surface during relative rotation therebetween.

39. The hydrodynamic bearing assembly of claim 38, wherein during relative rotation between said dynamic race surface and said dynamic washer surface, said dynamic interface is lubricated substantially the same during either clockwise or counter-clockwise relative rotation.

40. The hydrodynamic bearing assembly of claim 22, wherein each said notch of said plurality of notches is substantially bilaterally symmetrical.

41. A hydrodynamic bearing assembly comprising:
a first race having a first race dynamic surface;
a second race having a second race dynamic surface; and
a thrust washer positioned between said first race and said second race, said thrust washer having a first dynamic washer surface facing said first race dynamic surface and a second dynamic washer surface facing said second race dynamic surface, said thrust washer having a plurality of notches extending generally radially through said thrust washer, said plurality of notches separated by a plurality of pedestals,
wherein each of said plurality of notches defines first and second washer flexing regions.

42. The hydrodynamic bearing assembly of claim 41, wherein said plurality of notches is located midway between said first and second dynamic washer surfaces.

43. The hydrodynamic bearing assembly of claim 41, wherein said plurality of notches is located closer to one said dynamic washer surface than to the other said dynamic washer surface.

44. The hydrodynamic bearing assembly of claim 41, wherein each of said plurality of notches includes a weakening geometry extending generally radially through said thrust washer.

45. The hydrodynamic bearing assembly of claim 44, wherein said weakening geometry is located substantially midway between an adjacent pair of said plurality of pedestals.

46. The hydrodynamic bearing assembly of claim 41, wherein said thrust washer includes a peripheral undercut defining a flexible ledge.

47. The hydrodynamic bearing assembly of claim 41, wherein said thrust washer includes a lubricant passage.

48. The hydrodynamic bearing assembly of claim 47, wherein said lubricant passage is a recessed slot in at least one of said dynamic washer surfaces.

49. The hydrodynamic bearing assembly of claim 47, wherein said lubricant passage is a hole that passes through said thrust washer from one of said dynamic washer surfaces to one of said plurality of notches.

50. The hydrodynamic bearing assembly of claim 41, further comprising a lubricant lubricating a dynamic interface between said first race dynamic surface and said first dynamic washer surface during relative rotation therebetween.

51. The hydrodynamic bearing assembly of claim 50, wherein during relative rotation between said first race dynamic surface and said first dynamic washer surface, said dynamic interface is lubricated substantially the same during either clockwise or counter-clockwise relative rotation.

52. The hydrodynamic bearing assembly of claim 50, wherein said lubricant is a pressurized lubricant and a film of lubricant is swept into said dynamic interface during relative rotation between said first race dynamic surface and said first dynamic washer surface.

53. The hydrodynamic bearing assembly of claim 41, wherein said thrust washer elastically deforms in use to provide a hydrodynamic fluid wedge at a dynamic interface between said first dynamic washer surface and said first race dynamic surface.

54. The hydrodynamic bearing assembly of claim 41, wherein each said notch of said plurality of notches is substantially bilaterally symmetrical.
